(19) United States
(12) Patent Application Publication
(10) Pub. No.: US 2020/0189035 A1
(43) Pub. Date: Jun. 18, 2020

(54) Method and Device for Fusion Welding One or a Plurality of Steel Sheets Made of Press-Hardenable Steel

(71) Applicant: Baosteel Tailored Blanks GmbH, Duisburg (DE)

(72) Inventors: Jana von der Heydt, Duisburg (DE); Christian Both, Duisburg (DE); Michael Kessler, Bergheim (DE)

(21) Appl. No.: 16/644,334

(22) PCT Filed: Aug. 9, 2018
(86) PCT No.: PCT/EP2018/071571

§ 371 Date: Mar. 4, 2020

(30) Foreign Application Priority Data
Sep. 7, 2017 (DE) 10 2017 120 611.6

(51) Int. Cl. B23K 26/24; B23K 35/30; B23K 35/365; B23K 35/38; B23K 26/12; B23K 35/40; B23K 26/144; B23K 26/00; B23K 26/70

(52) U.S. Cl. CPC B23K 26/24; B23K 35/3053; B23K 35/365; B23K 35/383; B23K 2101/18; B23K 35/404; B23K 26/144; B23K 26/0006; B23K 26/70; B23K 26/123

(57) ABSTRACT

A method and a device for fusion welding one or more steel sheets made of press-hardenable steel, preferably manganese-boron steel; are disclosed. In the method, the fusion welding is performed by supplying filler wire into a molten bath generated a laser beam. In order to improve the hardenability of the weld seam, regardless of whether the steel sheets to be welded to one another are steel sheets of identical or different material quality, the filler wire is coated with graphite particles prior to fusion welding and the filler wire coated in this manner is introduced directly into the molten bath in such a way that the tip of the filler wire melts in the molten bath, the graphite particles are mixed with a waxy or liquid carrier medium to be applied to the filler wire, and the mixture is applied in the form of a coating to the filler wire. The method and the corresponding device are distinguished by a high productivity and a relatively low energy consumption. The method can be implemented with a relatively low equipment outlay.

The invention relates to a method for fusion welding one or a plurality of steel sheets made of press-hardenable steel, preferably manganese-boron steel, in which method the fusion welding is performed with supply of filler wire into the molten bath generated exclusively by means of a laser beam.

Moreover, the invention relates to a device for fusion welding one or a plurality of steel sheets, in particular to carry out the method of the above-mentioned type, with a laser welding head and a wire supplying device to supply filler wire into the molten bath generated exclusively by means of a laser beam.

So-called hot formable, i.e. press-hardenable sheets made of manganese-boron steel, for example of the steel grade 22MnB5 are increasingly gaining relevance in automobile manufacture. In the delivery state, i.e. prior to press hardening, manganese-boron steels have a tensile strength of approx. 600 MPa and a ferritic-perlitic structure. A fully martensitic structure can be set by press hardening and the associated rapid cooling after forming, which can have tensile strengths in the region of 1500 to 2000 MPa. Such components are often manufactured from so-called tailor welded blanks; this means that a connection takes place between different requirements-specific sheet thicknesses and/or material qualities, usually by means of laser welding.

In the hot forming and hardening process, in which the tailor welded blanks are further processed, their weld seam should be generally hardened to the same extent as the base materials of the steel plates of which the tailor welded blanks are composed. Ensuring this can pose significant challenges to the hot forming process for example during welding of steel plates of different thickness, in which a relatively large thickness jump results at the joint. The process window (parameter window) for an adequate hardening process is then relatively small. In addition, the hardening process is sensitive and must be set very precisely which often entails production-related restrictions for the user.

Fusion welding of hot-formable press-hardenable steel sheets is further restricted by the surface coating that is often provided and is made of aluminium. Such a coating e.g. an aluminium-silicone coating is usually provided in order to prevent scaling of the workpieces during hot forming. However, this surface coating affects the quality of weld seams very negatively since the aluminium-containing surface coating, in addition to the base material, is melted during the fusion welding of the coated steel sheets and as a result aluminium is introduced into the weld seam. If the aluminium content in the weld seam is between 2 and 10% by weight, formation of ferritic regions (phases) results, which lead to a reduction in the strength of the weld seam. The strength of the weld seam is, in such cases, below that of the base material such that failure of the relevant component in the weld seam is to be expected, irrespective of the joined sheet thickness combination.

In order to prevent the ferrite formation, according to the prior art an at least partial removal of the surface coating in the edge region of the sheet edges to be welded together is carried out prior to the welding process by means of mechanical tools or by means of laser ablation (cf. EP 2 007 545 B1). However, an additional process step is required for this at least partial removal of the surface coating which is costly and also time consuming and therefore impairs the economic efficiency of the finish of components of the type described here.

In US 2008/0011720 A1, a laser arc hybrid welding process is described, in which plates made of manganese-boron steel, which have an aluminium-containing surface layer, are connected to one another in a butt joint. The laser beam is combined here with at least one electric arc in order to melt the metal at the butt joint and to weld the plates together. The electric arc is formed by means of a wolfram welding electrode or forms while using a MIG welding burner at the tip of a filler wire. The filler wire can contain elements (e.g. Mn, Ni and Cu) which induce the conversion of the steel into an austenitic structure and facilitate the maintenance of the austenitic conversion in the molten bath. With this hybrid welding process it should be achieved that hot-formable plates made of manganese-boron steel can be welded, which are provided with an aluminium-silicone-based coating, without prior removal of the coating material in the region of the weld seam to be produced, and it should still be ensured that aluminium located at the joint edges of the plates does not lead to a reduction of the strength of the component in the weld seam. By providing an electric arc behind the laser beam, the molten bath should be homogenised and therefore local aluminium concentrations greater than 1.2% by weight, which produce a ferritic structure, should be eliminated.

This known hybrid welding process is relatively costly in terms of the energy consumption owing to the production of the electric arc. Furthermore, the welding speed is comparatively low. In addition, a weld seam produced by laser arc hybrid welding has a seam shape unfavourable for further forming which, where appropriate, requires subsequent processing.

A method of laser welding sheets made of press-hardenable manganese-boron steel in a butt joint using filler wire is known from EP 2 919 942 B1, with the filler wire containing at least one alloy element from the group comprising manganese, chromium, molybdenum, silicone and/or nickel, which favours the formation of austenite in the molten bath generated using the laser beam and with this at least one alloy element being present in the filler wire with a mass proportion greater by at least 0.1% by weight than in the press-hardenable steel of the steel sheets. The filler wire in this case has the following composition: 0.05 to 0.15% by weight C, 0.5 to 2.0% by weight Si, 1.0 to 2.5% by weight Mn, 0.5 to 2.0% by weight Cr+Mo and 1.0 to 4.0% by weight Ni, remainder iron and unavoidable impurities, with the filler wire having a carbon mass proportion lower by at least 0.1% by weight than the press-hardenable steel of the steel sheets. In addition the method is characterised in that the steel sheets used are uncoated or were, prior to welding, partially decoated by ablating their coating in the edge region along the joint edges to be welded together.

A laser welding method to manufacture tailor welded blanks made of coated steel sheets using filler wire is described in EP 2 737 971 A1, with the steel sheets used consisting of boron-alloyed steel and having an aluminium-silicone or zinc-coating. The filler wire contains carbon or manganese, with the mass proportion of this element being greater in the filler wire than in the base material of the coated steel sheets. Thus, the carbon content of the filler wire should be 0.1% by weight to 0.8% by weight and its manganese content should be 1.5% by weight to 7.0% by weight higher than that of the base material of the steel sheets. A reduction in the strength of the weld seam as a result of the ingress of coating material into the molten bath generated by the laser beam should hereby be prevented compared to press-hardened steel sheets.

EP 2 736 672 B1 discloses a method of manufacturing a component made of coated steel sheets by laser welding using filler wire, with the steel sheets having an aluminium-based coating which has been removed, prior to welding, in the edge regions along the joint edges to be welded together to such an extent that an intermetallic alloy layer still remains there. The filler wire has, in this known method, the following composition: 0.6 to 1.5% by weight C, 1.0 to 4.0% by weight Mn, 0.1 to 0.6% by weight Si, max 2.0% by weight Cr and max 0.2% by weight Ti, remainder iron and impurities caused by the processing.

DE 10 2010 019 258 A1 describes a method of manufacturing steel sheet products, in the case of which plates made of manganese-boron steel of different thickness are welded along a joint by means of a laser beam, with a viscous liquid being applied prior to the welding process on at least one joint edge of the steel plates to be welded together, said viscous liquid containing at least one component increasing the strength of the weld seam to be generated. For example, mineral oil or a liquid, in which graphite particles are dispersed, is used as the viscous liquid here.

The object underlying the present invention is to indicate a method or device of the type mentioned in the introduction, with which steel sheets, from which at least one sheet is made of press-hardenable steel and has an aluminium coating, can be joined such that decreases in hardness in the weld seam after the hot forming (press hardening) can be absorbed, and the method or the device should be distinguished by high productivity and a comparable low energy consumption. In particular, a method of the type mentioned in the introduction should be indicated, by way of which the hardenability of the weld seam is improved, and this is independently of whether the steel sheets to be welded together are steel sheets of the same or different material qualities. Moreover, the system-related effort to implement the method should also be relatively low. A method or a device of the type mentioned in the introduction should thus be provided by means of which coated sheets made of press-hardenable steel, in particular such with an aluminium-based coating, can be welded together in an efficient manner and the hardenability of the weld seam is improved such that the process window for an adequate hardening process is enlarged and production-related restrictions for the user are reduced.

In order to achieve this object, a method with the features indicated in claim 1 and a device with the features indicated in claim 13 are proposed. Preferred and advantageous configurations of the method or device according to the invention are indicated in the dependent claims.

The invention provides, in the case of a laser welding method of the type mentioned in the introduction, that the filler wire is coated with graphite particles prior to fusion welding and the filler wire coated in this manner is introduced directly into the molten bath such that the tip of the filler wire melts in the molten bath, with the graphite particles being mixed with a waxy or liquid carrier medium to be applied on the filler wire and the mixture is applied as a coating on the filler wire.

The hardenability of the weld seam is significantly improved by the additional carbon from the coating of the filler wire containing graphite, irrespective of whether the steel sheets to be welded together are sheets of the same or different material qualities. The method according to the invention offers in particular the perspective, in the case of laser welding of press-hardenable steel sheets, e.g. the same type of manganese-boron steel sheets of different sheet thickness, which have an aluminium-based coating, of omitting a part of the decoating process or even the entire process in the edge region of the sheet edges to be welded to one another. By omitting the decoating process, the productivity of such a laser welding method can be notably increased. Unlike a laser arc hybrid welding method, the laser welding method according to the invention enables relatively high welding speeds.

In addition, the laser welding method according to the invention, unlike the laser arc hybrid method, offers the advantage that the generated laser weld seam is relatively narrow and is distinguished by an improved seam geometry.

An advantage of the method according to the invention compared to the use of a carbon-containing filler wire, such as in the case of the method known from EP 2 737 971 A1, is that essentially any conventional filler wire can be used and coated with graphite particles. The filler wire used to carry out the method according to the invention should, however, be or is, aside from unavoidable impurities, preferably aluminium-free. It is thus not necessary for carrying out the method according to the invention, to make or provide a special filler wire. Therefore, the delivery is also possible through a plurality of filler wire suppliers. The carbon content introducible into the molten bath is here substantially limited only by the absorbability of the carrier medium or the dispersibility of the graphite particles in the carrier medium serving as the coating material and by the absorbability of the molten bath.

An advantage of the method according to the invention compared to the application, known from DE 10 2010 019 258 A1, of a viscous liquid on a joint edge of the steel plates to be welded together, with the viscous liquid containing at least one component increasing the strength of the weld seam to be generated, e.g. graphite particles is that the introduction of carbon into the molten bath and therefore into the weld seam by means of a corresponding coating of the filler wire is notably more even and more effective than by means of coating the joint edges. In addition, the system-related implementation of the method according to the invention is less complex than in the case of coating the joint edges with a viscous liquid of the mentioned type.

The method according to the invention can be used not only in the case of joining a plurality of steel plates of the same or different sheet thickness, of which at least one plate is manufactured from press-hardenable steel, preferably manganese-boron steel, but rather in particular also in the case of laser welding an individual plate-shaped or strip-shaped steel sheet made of press-hardenable steel, and in the latter case the sheet edges to be welded together by forming, for example by bending or roll-forming, are moved towards one another such that they are ultimately arranged facing one another in the butt joint. Moreover, it lies also within the meaning of the invention to use the method according to the invention in the case of laser welding one or a plurality of steel sheets made of press-hardenable steel, preferably manganese-boron steel, in the overlap joint.

A preferred configuration of the invention provides that the filler wire is coated with graphite particles at the location of fusion welding, preferably continually during the fusion welding operation. Thereby the production costs can be lowered. The invention can be implemented in a compact structure from a technical standpoint by the filler wire being coated at the location of fusion welding, with the coating being carried out preferably continually during fusion welding. The coating quantity applied on the filler wire can be suitably set as a function of the wire supplying speed and/or the welding speed within a determined quantity range. This configuration in particular includes the option of suitably setting the coating quantity or the graphite particle content of the coating material as a function of the composition of the steel sheets to be welded together, in particular as a function of the type and/or thickness of the surface coating of the steel sheets such that the weld seam has a comparable or preferably even a higher hardness and strength with respect to the base material of the steel sheets after the hot forming (press hardening).

According to a further configuration of the invention, the filler wire is coated with graphite particles between a wire feed device and a guide line supplying the filler wire to the molten bath. In this manner, the filler wire can be coated with graphite particles close to the molten bath and the coated filler wire can be very reliably supplied to the molten bath.

The coating of the filler wire according to the invention can be achieved in different ways. The filler wire is preferably coated with graphite particles by means of a coating device in the form of a dipping bath, a roller application device or a spraying device. The roller application device can be provided here with one or a plurality of application rollers which are preferably provided in each case with an annular groove, whose cross-sectional profile is greater by a certain extent than the thickness or the diameter of the filler wire to be coated, with the filler wire being guided such that it engages at least partially in the annular groove. The quantity of the coating material to be applied can be or is set by controlling the rotational speed of the at least one application roller in relation to the feed speed of the filler wire.

In order to coat the filler wire with graphite particles, these graphite particles are mixed with a waxy or liquid carrier medium. The average particle size D50 of the graphite particles is here for example maximum 300 μm, preferably maximum 200 μm, particularly preferably maximum 100 μm. D50 means that 50% of the particles are smaller than the indicated value.

An advantageous configuration of the invention provides that, as the liquid carrier medium, oil, preferably paraffin oil, for example white oil is used. In such a carrier medium, graphite particles can be dispersed very stable. The mixture can also contain stabilisers and/or additives, for example wetting agents or other dispersing agents. Moreover, oil, in particular mineral oil or paraffin oil itself has a high carbon proportion, which contributes to improved hardenability of the weld seam.

The solid content of the mixture composed of graphite particles and carrier medium for coating the filler wire can for example be in the range of 20 to 80% by weight, preferably in the range of 40 to 80% by weight.

According to a further configuration of the method according to the invention, the steel sheet(s) has/have an aluminium or aluminium-silicon-based surface layer which extends to at least one longitudinal edge, to be welded, of the steel sheet(s). This configuration offers cost advantages since, in the case of this configuration, the additional process step of removing the aluminium coating in the region of the sheet edges to be welded, in the case of sufficient carbon contribution, can be omitted. In addition, this configuration, unlike conventional laser welding of aluminium-coated manganese-boron steel sheets, after prior decoating of the edges of the sheet edges to be joined in the butt joint, yields an optimal weld seam geometry in the form of a larger supporting cross-section. This improves in particular the dynamic load-bearing capacity of the weld seam or reduces the material fatigue in the region of the weld seam.

Steel sheet(s) made of press-hardenable steel sheet, in particular manganese-boron steel, which is/are joined using the method according to the invention, have for example a thickness of at least 1.8 mm or at least 2.0 mm. The steel sheets can have a different sheet thickness and/or a different material quality, in particular tensile strength in this case.

The method according to the invention is in particular provided for welding steel sheet(s) made of press-hardenable steel, e.g. manganese-boron steel, which is/are welded in the butt joint, with a thickness jump of at least 0.4 mm resulting at the butt joint. The thickness jump can result by using steel sheets of different sheet thickness or in the case of using individual steel sheet or steel sheets of the same sheet thickness through an offset of the sheet edges to be joined to one another.

A further configuration of the invention provides that the proportion of graphite particles in the mixture made of carrier medium and graphite particles is set such that the filler wire, after the mixture has been applied on the filler wire as the coating, has a carbon mass proportion of at least 0.2% by weight, preferably of at least 0.3% by weight. In this way, it is already achieved in many cases that the weld seam, after press hardening the steel sheet workpiece, has a hardness or strength comparable with the base material of the steel sheets.

According to a further preferred configuration of the invention, the proportion of graphite particles in the mixture of carrier medium and graphite particles is set such that the filler wire, after the mixture has been applied on the filler wire as a coating, has a carbon mass proportion which is higher by 0.1% by weight to 1.2% by weight than the carbon mass proportion of the base material of the steel sheet(s).

Optionally, the still uncoated filler wire can, prior to the coating according to the invention, contain at least one alloy element which favours the formation of austenite in the molten bath generated with the laser beam. The hardenability of the weld seam is hereby further improved, irrespective of whether the steel sheets to be welded together are steel sheets of the same or different material quality.

In order to prevent embrittlement of the weld seam, a further configuration of the invention provides that inert gas is applied to the molten bath during the laser welding. The inert gas used is preferably pure argon, helium, nitrogen or their mixture or a mixture of argon, helium, nitrogen and/or carbon dioxide and/or oxygen.

A further configuration of the invention provides that the steel sheet(s) is/are joined during laser welding in the butt joint or overlap joint with gap of less than 0.8 mm, preferably of less than 0.6 mm, particularly preferably less than 0.4 mm. A small gap width in the range of a few tenths of a millimetre favours a high welding speed and therefore high productivity of the welding method. In addition, a small gap width in the indicated range favours the optimisation of the seam geometry.

In a preferred configuration of the invention, the steel sheet(s) to be welded is/are selected such that their base material has the following composition: 0.10 to 0.50% by weight C, max. 0.40% by weight Si, 0.50 to 2.00% by weight Mn, max. 0.025% by weight P, max. 0.010% by weight S, max. 0.60% by weight Cr, max. 0.50% by weight Mo, max. 0.050% by weight Ti, 0.0008 to 0.0070% by weight B, and min. 0.010% by weight Al, remainder Fe and unavoidable impurities. The components (workpieces) produced from such a steel have a relatively high tensile strength after press hardening.

Manganese-boron steel sheets are further preferably used in the method according to the invention, which have a tensile strength in the range of 1500 to 2000 MPa after press hardening.

The filler wire used in the method according to the invention preferably has the following composition: 0.1 to 0.4% by weight C, 0.5 to 2.0% by weight Si, 1.0 to 2.5% by weight Mn, 0.5 to 5.0% by weight Cr+Mo and 1.0 to 4.0% by weight Ni, remainder iron and unavoidable impurities. Test have shown that a strong conversion of the weld seam into a martensitic structure during press hardening of the joined steel sheets can be ensured with such a filler wire when using the method according to the invention.

The object underlying the present invention and indicated above is further achieved by a device for fusion welding one or a plurality of steel sheets, with the device having a laser welding head, a wire supplying device to supply filler wire into the molten bath generated exclusively by means of a laser beam and a coating device, by means of which the filler wire is coated with a waxy or liquid mixture containing graphite particles.

The coating device formed as a component of the device according to the invention is for example configured in the form of a dipping bath, a roller application device or a spraying device. It is arranged, according to a preferred configuration of the invention, between a wire feed device and a guide line supplying the filler wire to the molten bath. The advantages already indicated above in relation to the method according to the invention can be hereby achieved.

The invention is explained in detail below on the basis of a drawing representing a plurality of exemplary embodiments. They show schematically:

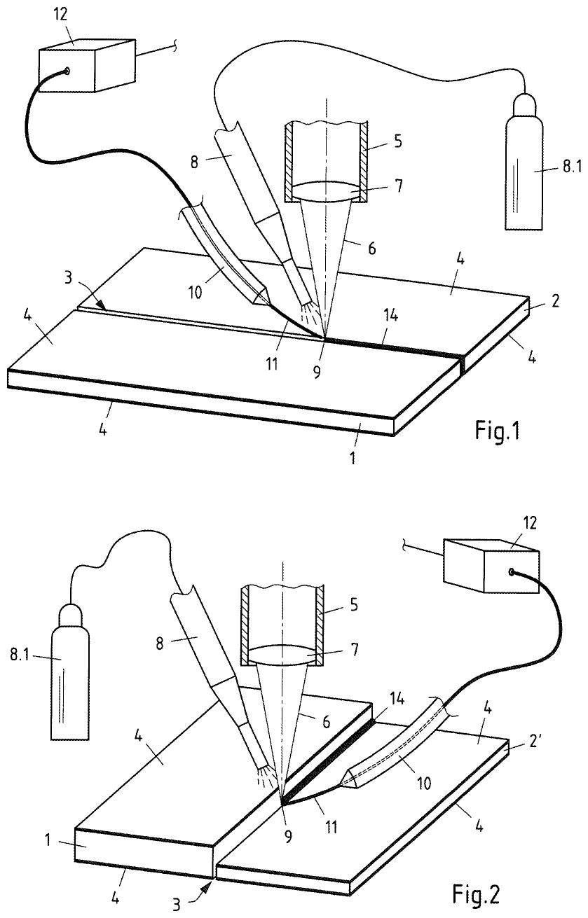

FIG. 1 a perspective representation of parts of a device for carrying out the fusion welding method according to the invention, with two substantially equally thick, press-hardenable steel sheets being welded together in the butt joint by means of a laser beam using filler wire;

FIG. 2 a perspective view of parts of a device for carrying out the fusion welding method according to the invention, with two differently thick, press-hardenable steel sheets being welded together in the butt joint by means of a laser beam using filler wire;

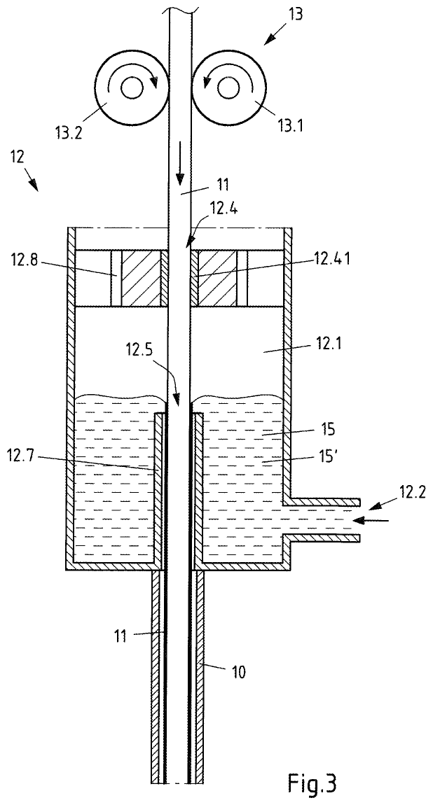

FIG. 3 a longitudinal sectional view of a coating device for coating a filler wire for a laser welding device according to FIG. 1 or FIG. 2;

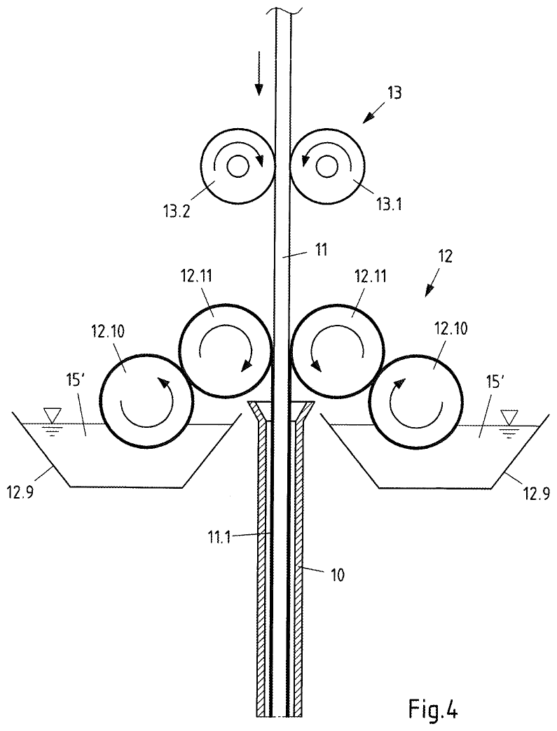

FIG. 4 a further exemplary embodiment of a coating device for coating a filler wire for a laser welding device according to FIG. 1 or FIG. 2, in a front or side view, with a wire supplying line being represented in the longitudinal section; and

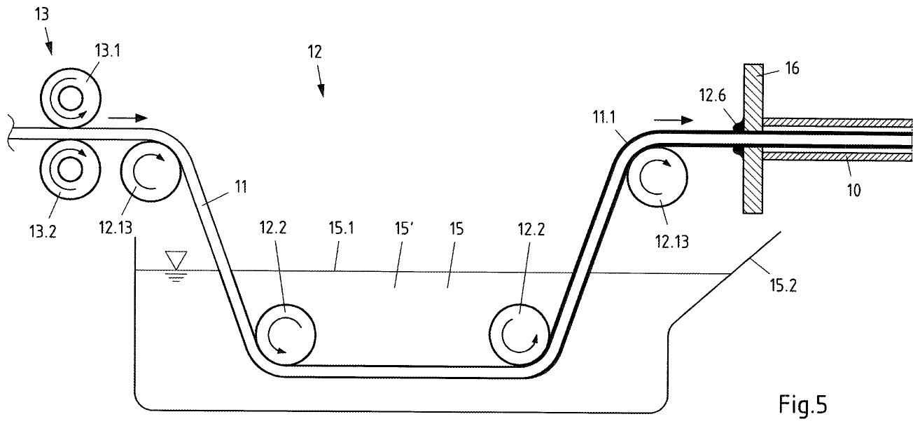

FIG. 5 another exemplary embodiment of a coating device for coating a filler wire for a laser welding device according to FIG. 1 or FIG. 2, in a front or side view, with the components of the device being represented partially in a vertical section.

A laser welding device is sketched in FIGS. 1 and 2, by means of which the method according to the invention can be carried out. The device comprises an underlay (not shown) on which two strips or plates 1, 2 made of steel of equal or different material qualities are arranged such that their edges to be welded together lie to one another as a butt joint. At least one of the steel sheets 1, 2 is produced from press-hardenable steel, preferably manganese-boron steel. The steel sheets 1, 2 are joined with a gap 3 of a few tenths of a millimetre in the butt joint. The gap 3 is for example less than 0.6 mm, preferably less than 0.4 mm. As far as the steel sheets 1, 2 are produced from steel of different material qualities, one steel sheet 1 or 2 for example has a relatively soft deep-drawing grade, while the other steel sheet 2 or 1 consists of higher strength steel.

The press-hardenable steel, of which at least one of the steel sheets 1, 2 to be connected to one another consists, can for example have the following chemical composition:
Max. 0.45% by weight C,
Max 0.40% by weight Si,
Max 2.0% by weight Mn,
Max 0.025% by weight P,
Max 0.010% by weight S,
Max 0.8% by weight Cr+Mo,
Max 0.05% by weight Ti,
Max 0.0050% by weight B, and
Min 0.010% by weight Al,
Remainder Fe and unavoidable impurities.

In the delivery state, i.e. prior to a heat treatment and rapid cooling, the press-hardenable steel plates 1, 2 have a yield strength Re of preferably at least 300 MPa; their tensile strength Rm is e.g. at least 480 MPa, and their elongation at break A₈₀ is preferably at least 10%. Following hot forming (press hardening), i.e. heating to austenitization temperature of approx. 900 to 950° C., forming at this temperature and subsequent rapid cooling, the steel plates 1, 2 have a yield strength Re of approx. 1100 MPa, a tensile strength Rm of approx. 1500 to 2000 MPa and an elongation at break Aso of approx. 5.0%.

The steel sheets 1, 2 are preferably provided with a metallic coating 4 made of aluminium or zinc. It is for example an Al—Si coating. The metallic surface coating 4 is applied to the base material preferably on both sides, for example by hot dip coating, by guiding a strip made of press-hardenable steel, preferably manganese-boron steel through a zinc or Al—Si molten bath, blowing off excessive coating material from the strip and the coated strip then subsequently treated, in particular heated. The aluminium content of the surface coating 4 can be in the range of 70 to 90% by weight.

Alternatively, only one of the steel sheets 1, 2 to be welded can also have an aluminium or zinc-containing surface coating 4. Furthermore, the surface coating 4 may, where appropriate, be applied only on one side of the steel sheet(s) 1, 2, e.g. by means of physical vapour deposition (PVD) or by means of an electrolytic coating process.

The steel sheets 1, 2 can, as shown in FIG. 1, have substantially the same thickness. The sheet thickness is for example in the range of 0.8 to 3.0 mm, preferably in the range of 1.8 mm to 3.0 mm, while the thickness of the metallic surface coating 4 on the respective sheet side can be less than 100 μm, in particular less than 50 μm.

A section of a laser welding head 5 is sketched above the steel sheets 1, 2, which is provided with optics to form and align a laser beam 6, in particular a focussing lens 7. The laser beam 6 is generated for example by means of an Nd:YAG laser system which delivers an output in the range of 5 to 6 kW.

A line 8 for supplying inert gas is assigned to the laser welding head 5. The discharge of the inert gas line 8 is substantially directed to the molten bath 9 generated with the laser beam 6 and the weld seam 14. A pressurised gas tank serving as the inert gas source is designated with 8.1. Pure argon or for example a mixture of argon, helium and/or carbon dioxide is preferably used as the inert gas.

In addition, a guide line 10 is assigned to the laser welding head 5 by means of which a filler material in the form of a wire 11 is supplied to the molten bath 9, with the tip of the filler wire 11 being melted in the molten bath 9. The filler wire 11 contains substantially no aluminium. It may for example have the following chemical composition:
0.1% by weight C,
0.8% by weight Si,
1.8% by weight Mn,
0.35% by weight Cr,
0.6% by weight Mo, and
2.25% by weight Ni,
Remainder Fe and unavoidable impurities.

The exemplary embodiment sketched in FIG. 2 differs from the example shown in FIG. 1 in that the steel sheets 1, 2′ have different thicknesses such that a thickness jump d is present at the butt joint. For example, the steel sheet 2′ has a sheet thickness in the range of 0.8 mm to 1.2 mm, while the other steel sheet 1 has a sheet thickness in the range of 1.6 mm to 3.0 mm. Moreover, the steel sheets 1, 2′ to be connected together in the butt joint can also differ from one another in their material quality. For example, the thicker plate 1 is produced from a higher-strength steel, whereas the thinner steel plate 2′ has a relatively soft deep-drawing grade. The steel sheets 1, 2′ are also joined to one another with a gap 3 of a few tenths of a millimetre.

According to the invention, the laser welding device comprises a coating device 12 by means of which the filler wire 11 is coated with a waxy or liquid mixture containing graphite particles. The coating device 12 indicated in FIGS. 1 and 2 only in the form of a box can be implemented in different embodiments. It is preferably arranged between a wire feed device 13 and the guide line 10 supplying the filler wire 11 to the molten bath 9 (cf. FIGS. 3 to 5).

An exemplary embodiment is represented in FIG. 3, in which the coating device 12 has a chamber 12.1 as a reservoir for receiving a liquid coating agent. The chamber 12.1 therefore contains a dipping bath 15 formed of liquid coating agent. The coating agent is supplied to the chamber 12.1 via an inlet opening 12.2, which discharges for example into the chamber 12.1 close to its bottom 12.3. The liquid coating agent is a mixture of a liquid carrier medium and graphite particles. The carrier medium is preferably oil, particularly preferably paraffin oil, for example so-called white oil.

The chamber 12.1 has an inlet 12.4 and an outlet 12.5 to channel a filler wire 11 to be coated. A wire feed device 13 is arranged upstream of the inlet 12.4 which has at least one drive roller 13.1 and a counter roller 13.2 which abut on the filler wire 11 with a certain pressing force.

The opening or cross-sectional surface of the outlet 12.5 is greater by a certain extent than the cross-sectional surface of the uncoated filler wire 11. The outlet 12.5 and the filler wire 11 therefore delimit an annular gap 12.6, whose radial gap dimension corresponds roughly to the desired thickness of a shell-shaped coating 11.1 to be applied on the filler wire 11. The gap dimension of the annular gap 12.6 is selected corresponding to the coating material quantity to be applied. Alternatively or additionally, the outlet 12.5 of the chamber 12.1 can be provided with a variably settable annular orifice by means of which the gap dimension of the annular gap 12.6 present between the filler wire 11 and the outlet opening 12.5 is variably, preferably continuously settable.

The inlet 12.4, through which the filler wire 11 to be coated enters the chamber 12.1, is arranged and dimensioned such that the filler wire 11 is guided as concentrically as possible to the inner wall of the outlet 12.5. The inlet 12.4 can to this end be delimited by a slide guide 12.41.

The outlet 12.5 of the chamber 12.1 can for example be defined by a sleeve 12.7 which preferably has a cylindrical inner wall and protrudes into the interior of the chamber 12.1. Alternatively, the sleeve 12.7 could also protrude at the outside, e.g. at the underside of the chamber 12.1. The guide line 10 guiding the coated filler wire 11 during the fusion welding process to the molten bath adjoins to the outlet 12.5. Moreover, the chamber 12.1 is provided above the dipping bath level 15.1 preferably with at least one venting or pressure compensation opening 12.8.

A further exemplary embodiment of a coating device 12 is represented in FIG. 4, by means of which filler wire 11 to be supplied to the molten bath 9 is coated during the fusion welding process. In this example, the coating device 12 is configured as a roller application system. The coating device 12 has at least one trough-shaped container 12.9 to receive liquid coating agent 15′. The coating agent 15′ is in turn a mixture of a liquid carrier medium and graphite particles. The carrier medium can in particular be paraffin oil, for example white oil.

At least one take-up roller 12.10 dipped partially into the coating agent 15′ is assigned to the trough-shaped container 12.9 which transfers coating agent 15′ received from the container 12.9 onto an application roller 12.11.

The application roller 12.11 is preferably provided with an annular groove (not shown), whose cross-sectional profile is greater by a certain extent than the cross-sectional profile of the filler wire 11 to be coated, with the filler wire 11 being guided such that it engages at least partially into the annular groove of the application roller 12.11. The take-up roller 12.10 can in this case have a circumferential projection (not shown) which also engages into the annular groove.

The quantity of the coating material to be applied can be or is set by controlling the rotational speed of the at least one application roller 12.11 and/or the at least one take-up roller 12.10 dipped into the coating agent in relation to the feed speed of the filler wire 11.

The filler wire 11 coated by means of the at least one application roller 12.11 or a plurality of such application rollers 12.11 is then supplied to the molten bath 9 generated by means of the laser beam 6 by the guide line 10. The wire feed device 13 arranged upstream of the coating device 12 according to FIG. 4 in turn has at least one drive roller 13.1 and a counter roller 13.2 which abut on the filler wire 11 with a frictional connection.

A further exemplary embodiment of a coating device 12 is represented in FIG. 5 by means of which filler wire 11 to be supplied to the molten bath 9 is coated during the fusion welding process. The coating device 12 in this case comprises a dipping bath 15 in which at least one deflection roller 12.12 is arranged immersed, such that the filler wire 11 conveyed in the direction of the guide line 10 by means of a wire feed device 13 arranged upstream of the dipping bath 15 is guided channelled the dipping bath 15. Further optional deflection rollers are designated with 12.13 which are arranged outside of the dipping bath 15. The deflection rollers 12.12, 12.13 are preferably provided with an annular groove (not shown), whose cross-sectional profile (width) is greater by a certain extent than the cross-sectional profile (diameter) of the filler wire 11 to be coated.

A stripping or layer thickness setting device 16 can be arranged between the deflection roller 12.2, arranged in the dipping bath 15, and the guide line 10, by means of which device the thickness or quantity of the coating material to be applied can be set. The stripping or layer thickness setting device 16 can for example be formed of at least one annular stripping screen and/or an inert gas or pressurised air nozzle (not shown) directed on the coated filler wire 11. The gap dimension of the annular gap between stripping screen and filler wire 11 is selected according to the coating material quantity to be applied. The stripping screen 16 is preferably variably settable, thus the gap dimension of the annular gap 12.6 present between the filler wire and the stripping screen is variably, preferably continuously settable. Excess coating material (coating agent) falls from the filler wire 11 on the stripping or layer thickness setting device 16 back into the dipping bath container 15.2.

Alternatively, the inlet opening of the guide line 10 can also be arranged in the dipping bath 15 such that the end of the guide line 10 immersed in the dipping bath 15 assumes the function of a layer thickness setting device.

The execution of the invention is not limited to the exemplary embodiments sketched in the drawing. In fact, numerous variants are conceivable which make use of the invention in the case of a configuration differing from the sketched examples, as is indicated in the enclosed claims. It is in particular in the scope of the invention to combine together individual or a plurality of the features of the exemplary embodiments explained on the basis of FIGS. 1 to 5.

### LIST OF REFERENCE NUMERALS

1 steel sheet (workpiece)
2 steel sheet (workpiece)
2′ steel sheet (workpiece)
3 gap (joint gap)
4 metallic coating, e.g. made of Al, Al—Si or Zn
5 laser welding head
6 laser beam
7 focussing lens
8 supply line for inert gas
8.1 inert gas supply
9 molten bath
10 guide line (filler wire supplying device)
11 filler wire
11.1 coating of 11
12 coating device
12.1 chamber
12.2 inlet opening
12.3 base
12.4 inlet
12.41 slide guide
12.5 outlet
12.6 annular gap
12.7 sleeve
12.8 venting or pressure compensation opening
12.9 trough-shaped container
12.10 take-up roller
12.11 application roller
12.12 deflection roller
12.13 deflection roller
13 wire feed device
13.1 drive roller
13.2 counter roller
14 weld seam
15 dipping bath (coating agent)
15′ coating agent
15.1 dipping bath level
15.2 dipping bath vessel (trough-shaped container)
16 stripping or layer thickness setting device
d thickness jump

1. A method of fusion welding one or a plurality of steel sheets made of press-hardenable steel, comprising ; supplying filler wire into a molten bath generated by a laser beam, wherein the filler wire is coated with graphite particles prior to fusion welding and the coated filler wire is introduced directly into the molten bath such that a tip of the filler wire melts in the molten bath, and wherein the graphite particles are mixed with a waxy or liquid carrier medium to be applied on the filler wire and the mixture is applied as a coating on the filler wire.

2. The method according to claim 1, wherein the filler wire is coated with the graphite particles at the location of the fusion welding.

3. The method according to claim 1, wherein the filler wire is coated with the graphite particles between a wire feed device and a guide line supplying the filler wire to the molten bath.

4. The method according to claim 1, wherein the filler wire is coated with the graphite particles by a coating device in the form of one of a dipping bath, a roller application device, and a spraying device.

5. The method according to claim 1, wherein oil is used as the liquid carrier medium.

6. The method according to claim 1, wherein the steel sheets have an aluminium or aluminium-silicone-based surface coating which extends to at least one longitudinal edge of the steel sheets.

7. The method according to claim 1, wherein the steel sheets have a thickness of at least 1.8 mm or at least 2.0 mm.

8. The method according to claim 1, wherein the steel sheets are welded a butt joint, and wherein a thickness of at least 0.4 mm results at the butt joint.

9. The method according to claim 1, wherein a proportion of the graphite particles in the mixture of the liquid carrier medium and the graphite particles is set such that the filler wire, after the mixture has been applied on the filler wire as the coating, has a carbon mass proportion of at least 0.2% by weight.

10. The method according to claim 1, wherein a proportion of the graphite particles in the mixture of the liquid carrier medium and the graphite particles is set such that the filler wire, after the mixture has been applied on the filler wire as the coating, has a carbon mass proportion which is higher by 0.1% by weight to 1.2% by weight than the carbon mass proportion of a base material of the steel sheets.

11. The method according to claim 1, wherein the filler wire when uncoated, contains at least one alloy element which favours the formation of austenite in the molten bath generated with the laser beam.

12. The method according to claim 1, wherein inert gas is applied to the molten bath during the fusion welding.

13. A device for fusion welding one or a plurality of steel sheets comprising:
a laser welding head;,
a guide line to supply filler wire into a molten bath generated by a laser beam; and
by a coating device in the form of a dipping bath by which the filler wire is coated with a waxy or liquid mixture containing graphite particles.

14. The device for fusion welding according to claim 13, wherein the coating device is arranged between a wire feed device and a guide line supplying the filler wire to the molten bath.

15. The device for fusion welding according to claim 13, wherein the coating device is configured in the form of one of the dipping bath, a roller application device, and a spraying device.

16. The method according to claim 1, wherein the press-hardenable steel is manganese boron steel.

17. The method according to claim 2, wherein the filler wire is coated continuously with the graphite particles at the location of the fusion welding.

18. The method according to claim 5, wherein the oil is paraffin oil.
